(19) United States
(12) Patent Application Publication
(10) Pub. No.: US 2010/0007618 A1
(43) Pub. Date: Jan. 14, 2010

(54) METHOD AND APPARATUS TO USE A USER INTERFACE

(75) Inventors: Yong Gook PARK, Yongin-si (KR); Min Kyn Park, Seoul (KR); Hyun Jin Kim, Seoul (KR); Ji Yeon Kwak, Seoul (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 12/370,800

(22) Filed: Feb. 13, 2009

(30) Foreign Application Priority Data
Jul. 9, 2008 (KR) 2008-66349

(51) Int. Cl. G06F 3/041

(52) U.S. Cl. 345/173

(57) ABSTRACT

A method to use a user interface includes when the user grips the apparatus in a standard shape, the controller identifies the griping fingers, perceives a commanded function based on the operations of the identified fingers, and executes the perceived function. Thus, a desired application or application function can be easily and quickly executed only by the operation of the fingers even when the handheld device is put in a bag or pocket, or when the user cannot check or handle the screen and buttons of the handheld device because the user is talking on the phone or in conference.

### CROSS-REFERENCE TO RELATED APPLICATIONS

This application claims priority under 35 U.S.C. §119(a) from Korean Patent Application No. 2008-0066349, filed Jul. 9, 2008 in the Korean Intellectual Property Office, the disclosure of which is incorporated herein in its entirety by reference.

### BACKGROUND OF THE INVENTION

1. Field of the Invention

The present general inventive concept relates to a method and apparatus to use a user interface, and, more particularly, to a method and apparatus to use a user interface to allow a user to easily, conveniently and quickly input a desired function through a touch input to perform the desired function, thereby improving conveniences in use.

2. Description of the Related Art

In general, a user interface apparatus includes a portable handheld device to provide various functions using many applications including wireless communication, for example, a cellular phone, a personal digital assistant (PDA), a smart phone, a portable multimedia player (PMP), a laptop, a tablet PC, a digital camera, a camcorder and the like. The handheld device usually refers to an electronic device operated while the electronic device is gripped with a hand.

Recently, as one example of the handheld device, a cellular phone is being developed to combine functions of another electronic device with main functions (calling and text messages) of the cellular phone along with development of technology. For example, in the recent trend, the cellular phone has many functions such as an MP3 reproduction function of an MP3 player, an image recording function and an image reproduction function of a digital camera, an electronic dictionary function and a digital TV function.

As various functions are included in the handheld device, it is more important to develop the user interface such that the user can easily and conveniently perform a desired function. For example, it is required for the user interface to reduce key input operations performed by the user to perform a specific function, or to allow the user to easily manage, search and execute multiple applications of photographs, moving pictures, music, e-mail and so forth.

Korean Patent Laid-open Publication No. 2007-001440 relates to a method and apparatus for function selection by a user's hand grip shape. In the Publication, several touch sensors are provided on an outer surface of the handheld device. The touch sensors sense the user's hand grip shape, for example, one-handed horizontal grip, one-handed vertical grip, two-handed horizontal grip or two-handed vertical grip, in which the user grips the handheld device with a hand or hands, to perform a calling function, a text input function, a photographing function or a game function. Accordingly, it is possible to relatively easily and conveniently execute an application through a touch input of the hand grip shape.

However, conventionally, it is possible to execute only an application of a calling function, a text input function, a photographing function or a game function according to the user's hand grip shape. For example, when the user intends to listen to the next song or the previous song while playing MP3 files of a handheld device put in a bag or pocket, the user should find and press a “NEXT” or “PREVIOUS” button while checking the screen and buttons of the mobile phone. Accordingly, it may cause trouble to the user to perform a desired function. Particularly, it is more troublesome when the handheld device is put in a bag or pocket, or when the user cannot check or handle the screen and buttons of the handheld device because he is talking on the phone or in a conference.

Further, conventionally, an application to be executed is perceived based on the user's hand grip shape. Accordingly, if there are many types of applications, the grip shape should be diversified for distinction and may cause inconvenience to the user.

### SUMMARY OF THE INVENTION

The present general inventive concept provides a method and apparatus to use a user interface to efficiently perform a desired function by identifying fingers gripping the apparatus, perceiving a commanded function based on operations of the identified fingers and executing the perceived function.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept may be achieved by providing a method to use a user interface, the method including sensing a standard hand grip, identifying gripping fingers when the standard hand grip is sensed, determining an operation of the identified fingers, perceiving a command based on the determined operation of the fingers, and executing the perceived command.

The foregoing and/or other aspects and utilities of the present general inventive concept may also be achieved by providing a user interface apparatus including a main body having at least two surfaces, touch pads provided on the at least two surfaces, a controller to identify gripping fingers when a standard hand grip is sensed through the touch pads, and to perceive and execute a command based on an operation of the identified fingers.

When the user grips the apparatus in a standard shape, the controller may identify the griping fingers, perceive a commanded function based on the operations of the identified fingers, and execute the perceived function. Thus, the user can easily, conveniently and quickly perform a desired application or application function.

A desired function can be easily and quickly executed only by the operation of the fingers even when the apparatus is put in a bag or pocket, or when the user cannot check or handle the screen and buttons of the handheld device because the user is talking on the phone or in conference.

The foregoing and/or other aspects and utilities of the general inventive concept may also be achieved by providing a handheld user interface apparatus including a main body to be held by a hand of a user, a plurality of touch pads disposed on the main body, and to correspond to and receive input from respective fingers of the hand of the user, and a controller to determine which of the touch pads receive input and a type of input received thereto, and to execute a command based on the determination.

The type of input may include one or more of a pressing operation, a pressing/moving operation, a contact removal operation, a contact duration operation, and a tapping operation, or a combination thereof.

The apparatus may further include a memory to store a plurality of commands, and combinations of the types of input to be received by the touch pads and the respective touch pads to receive the input required to execute the respective commands.

The foregoing and/or other aspects and utilities of the general inventive concept may also be achieved by providing a method of operating a handheld user interface apparatus, the method including determining which of a plurality of touch pads respectively corresponding to fingers of a hand of a user receive an input, determining a type of input received by the determined touch pads, and executing a command based on the determined plurality of touch pads to receive the input and the type of input received.

The foregoing and/or other aspects and utilities of the general inventive concept may also be achieved by providing a method of operating a handheld computer (HHC) including determining characteristics of finger placement on at least two touch pads disposed on sides of the HHC, and executing predetermined commands of the HHC based on the determined characteristics of the finger placement.

The determined characteristics of the finger placement may include a type of grip of the HHC.

The type of grip may include a pressure applied to the touch pads.

The characteristics of the finger placement may include positioning of the fingers and the number of fingers on the touch pad.

The foregoing and/or other aspects and utilities of the general inventive concept may also be achieved by providing a computer-readable recording medium having embodied thereon a computer program to execute a method, wherein the method including determining which of a plurality of touch pads respectively corresponding to fingers of a hand of a user receive an input, determining a type of input received by the determined touch pads, and executing a command based on the determined plurality of touch pads to receive the input and the type of input received.

### BRIEF DESCRIPTION OF THE DRAWINGS

These and/or other aspects and utilities of the present general inventive concept will become apparent and more readily appreciated from the following description of the embodiments, taken in conjunction with the accompanying drawings, of which:

FIG. 1 is a schematic control block diagram illustrating a handheld device according to an embodiment of the present general inventive concept;

FIGS. 2 to 9 are views illustrating various arrangements of touch pads in the handheld device according to the embodiment of the present general inventive concept;

FIG. 10 is a view illustrating a handheld device gripped by one hand of a user;

FIG. 11 is a view illustrating touch regions formed by the gripping fingers of the user illustrated in FIG. 10 in the respective touch pads;

FIG. 12 is a view illustrating a control flowchart illustrating a control method of the handheld device according to the embodiment of the present general inventive concept;

FIG. 13 is a view illustrating a control flowchart illustrating a process of determining a standard shape of hand grip in the handheld device according to the embodiment of the present general inventive concept;

FIGS. 14 to 16 are views illustrating various standard shapes of hand grip applicable to the handheld device according to the embodiment of the present general inventive concept;

FIG. 17 is a view illustrating a process of perceiving the application commanded based on operations of the fingers and executing the application in the handheld device according to the embodiment of the present general inventive concept;

FIG. 18 is an explanatory diagram illustrating a process of perceiving the application commanded according to the operations of the fingers in FIG. 17;

FIG. 19 is another example of a view illustrating a process of perceiving the application commanded of FIG. 17; and

FIG. 20 is an explanatory diagram illustrating a process of perceiving a function of the application under execution according to operations of the fingers in FIG. 19.

### DETAILED DESCRIPTION OF THE PREFERRED EMBODIMENTS

Reference will now be made in detail to exemplary embodiments of the present general inventive concept, examples of which is illustrated in the accompanying drawings, wherein like reference numerals refer to like elements throughout. The embodiments are described below to explain the present general inventive concept by referring to the figures.

Hereinafter, embodiments according to the present general inventive concept will be described in detail with reference to the accompanying drawings.

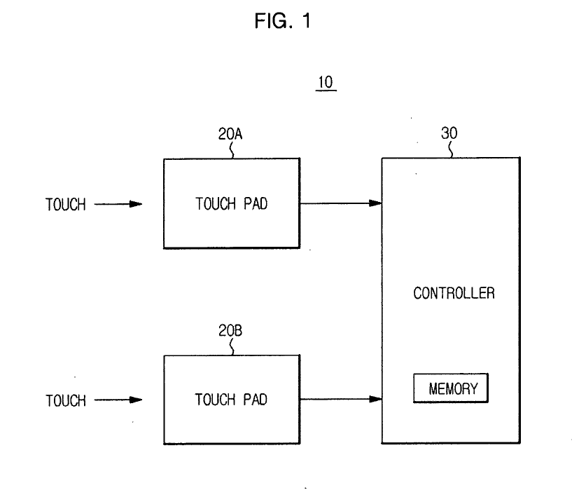

FIG. 1 is a schematic control block diagram illustrating a handheld device according to an embodiment of the present general inventive concept. The user interface apparatus may be, for example, a handheld device. The handheld device refers to a device operated while being gripped with a hand.

The handheld device may be operated by one-handed action or two-handed action. In the one-handed action, the device is supported and the operation is performed through the user interface using one hand. As representative examples of the handheld device to be operated with one hand, there are a cellular phone, a PDA, a media player, and a GPS unit. In a case of the cellular phone, for example, a user can grip the cellular phone with one hand while the phone is interposed between fingers and a palm of the hand and can input information through a key, a button or a navigation pad.

As illustrated in FIG. 1, a handheld device 10 includes two or more touch pads 20 enabling input into the handheld device 10 and a controller 30 to analyze the information input through the touch pads 20 to perform an entire control operation. The controller 30 includes a memory 31 to store various information and data. As will be described later, when the hand grip of the handheld device 10 in a standard shape is sensed through the touch pads 20, the controller 30 identifies griping fingers, perceives a commanded function based on operations of the identified fingers, and executes the function. Accordingly, the user can easily, conveniently and quickly perform a desired application or application function. Particularly, a desired function can be easily and quickly executed only by the operation of the fingers even when the handheld device is put in a bag or pocket, or when the user cannot check or handle the screen and buttons of the handheld device because the user is talking on the phone or in conference.

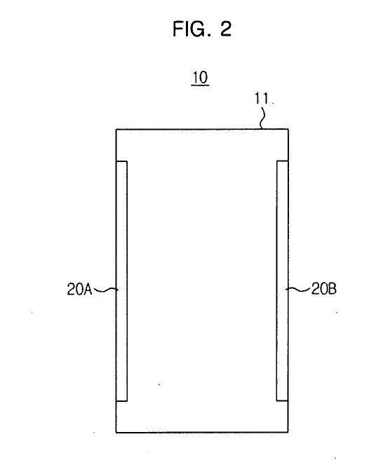

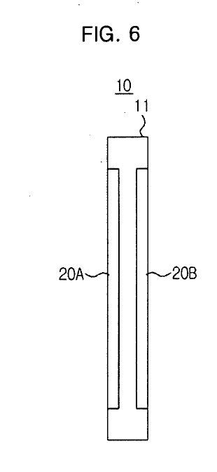

The touch pads 20 may be variously arranged on the handheld device 10. The configurations of the touch pads 20 are illustrated in FIGS. 2 to 9. FIGS. 2 to 5 are front views of the handheld device, and FIGS. 6 to 9 are side views of the handheld device.

Referring to FIGS. 2 to 9, the handheld device 10 may include a first touch pad 20A positioned on a first surface of a main body 11 of the handheld device 10 and a second touch pad 20B positioned on a second surface thereof. The first touch pad 20A and the second touch pad 20B positioned on different surfaces of the handheld device 10, may be positioned on any surfaces of the handheld device 10 including, for example, front, rear, upper, lower, left and/or right surfaces. Further, each of the touch pads 20A and 20B may occupy a certain area including a large area (e.g., the entire surface) or a small area (e.g., a portion of the surface).

Further, the handheld device 10 may include the first touch pad 20A positioned on the first surface of the handheld device 10, the second touch pad 20B positioned on the second surface, and a third touch pad 20C positioned on a third surface. Alternatively, the handheld device 10 may include the first touch pad 20A positioned on the first surface, the second touch pad 20B positioned on the second surface, the third touch pad 20C positioned on the third surface, and a fourth touch pad 20D positioned on a fourth surface. Also in these cases, the first touch pad 20A to the third touch pad 20C or the touch pad 20A to the fourth touch pad 20D positioned on the different surfaces of the handheld device 10 may be positioned on any surfaces of the handheld device 10 including, for example, front, rear, upper, lower, left and/or right surfaces. Further, each of the touch pads 20A to 20D may occupy a large or small area.

As illustrated in FIG. 2, the first touch pad 20A may be positioned on the left surface of the main body 11, and the second touch pad 20B may be positioned on the right surface of the main body 11.

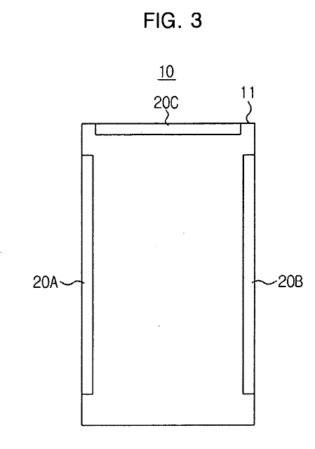

As illustrated in FIG. 3, the first touch pad 20A may be positioned on the left surface of the main body 11, and the second touch pad 20B may be positioned on the right surface of the main body 11. The third touch pad 20C may be positioned on the upper surface of the main body 11.

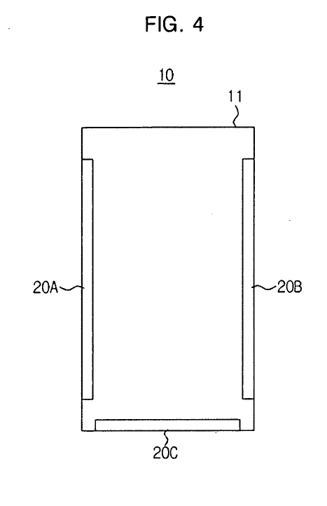

As illustrated in FIG. 4, the first touch pad 20A may be positioned on the left surface of the main body 11, and the second touch pad 20B may be positioned on the right surface of the main body 11. The third touch pad 20C may be positioned on the lower surface of the main body 11.

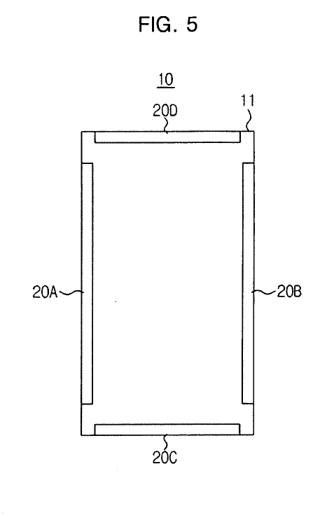

As illustrated in FIG. 5, the first touch pad 20A may be positioned on the left surface of the main body 11, and the second touch pad 20B may be positioned on the right surface of the main body 11. The third touch pad 20C may be positioned on the lower surface of the main body 11, and the fourth touch pad 20D may be positioned on the upper surface of the main body 11.

As illustrated in FIG. 6, the first touch pad 20A may be positioned on the front surface of the main body 11, and the second touch pad 20B may be positioned on the rear surface of the main body 11.

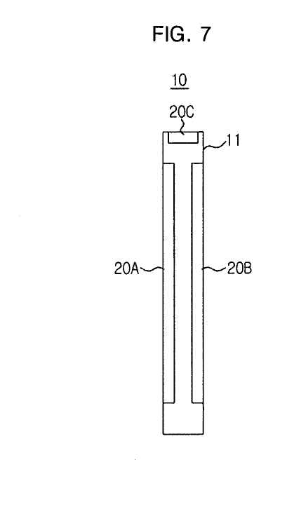

As illustrated in FIG. 7, the first touch pad 20A may be positioned on the front surface of the main body 11, and the second touch pad 20B may be positioned on the rear surface of the main body 11. The third touch pad 20C may be positioned on the upper surface of the main body 11.

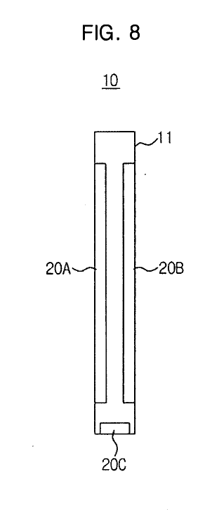

As illustrated in FIG. 8, the first touch pad 20A may be positioned on the front surface of the main body 11, and the second touch pad 20B may be positioned on the rear surface of the main body 11. The third touch pad 20C may be positioned on the lower surface of the main body 11.

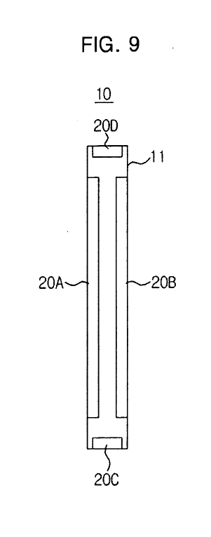

As illustrated in FIG. 9, the first touch pad 20A may be positioned on the front surface of the main body 11, and the second touch pad 20B may be positioned on the rear surface of the main body 11. The third touch pad 20C may be positioned on the lower surface of the main body 11, and the fourth touch pad 20D may be positioned on the upper surface of the main body 11.

In the handheld device 10, when the first touch pad 20A positioned on the first surface of the main body 11 and the second touch pad 20B positioned on the second surface are arranged to face each other, specifically, when the first touch pad 20A and the second touch pad 20B are arranged on the left and right surfaces, on the upper and lower surfaces, or on the upper and lower surfaces, one-handed action can be achieved. That is, any one finger of the fingers of the user may be used to support any one surface of the main body 11 and another finger may be used to operate the other surface.

Each of the touch pads 20 may be formed of a sensor arrangement 21. The sensor arrangement 21 can sense not only an existence of an object such as a finger, but also a position and pressure of the object applied to the surface of the touch pad. The sensor arrangement 21 may be based on, for example, capacitive sensing, resistive sensing and surface acoustic wave sensing. Further, the sensor arrangement 21 may be based on pressure sensing using a strain gauge, a force sensitive resistor, a load cell, a pressure plate and a piezoelectric transducer.

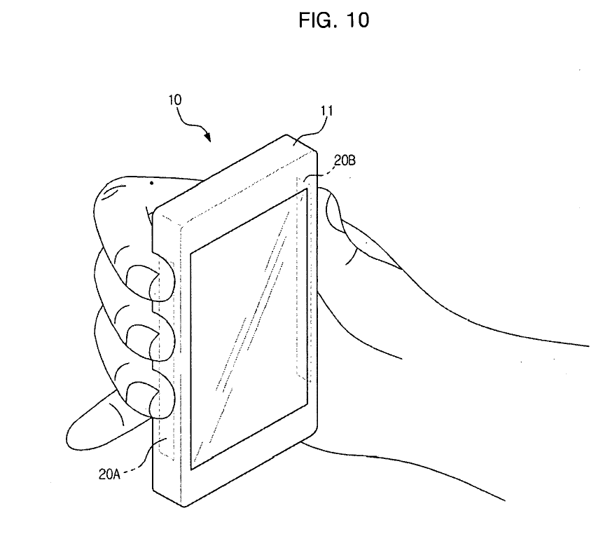

As illustrated in FIG. 10, when the second touch pad 20B is positioned on the right surface of the main body 11 of the handheld device 10 and the first touch pad 20A is positioned on the left surface of the main body 11, while the user grips the touch pads 20 with hands, a thumb of the user may perform a contact operation, a contact removal operation, a press operation, a press removal operation, a tapping operation or a dragging operation on the second touch pad 20B positioned on the right surface of the main body 11. Further, the index finger, the middle finger and the ring finger of the user may perform the same operations on the first touch pad 20A positioned on the left surface of the main body 11. The fingers may tap or press the touch surface, or may slide on the touch surface to produce an input. In this case, the contact operation refers to touching the touch pad 20 with the finger at a pressure below a predetermined value, and the press operation refers to touching the touch pad 20 with the finger at a pressure equal to or larger than a predetermined value. The tapping operation refers to touching the touch pad 20 with the finger at a pressure equal to or larger than a predetermined value after the finger in contact with the touch pad 20 is removed from the touch pad 20. The dragging operation refers to moving the finger while the finger touches the touch pad 20 at a pressure equal to or larger than a predetermined value.

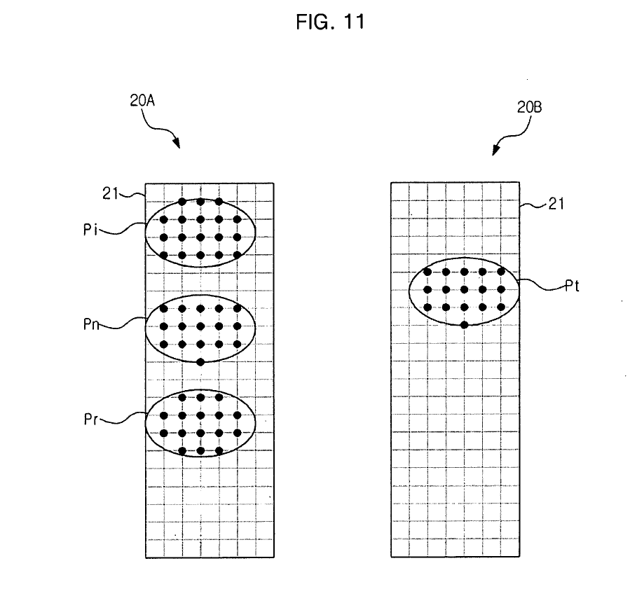

When the user grips the handheld device 10 of FIG. 10 and FIG. 11, a thumb touch region Pt touched by the thumb of the user is sensed by a sensor arrangement 21B of the second touch pad 20B, and respective touch regions Pi, Pn and Pr touched by the index finger, the middle finger and the ring finger are sensed by a sensor arrangement 21A of the first touch pad 20A.

Specifically, the sensor arrangement 21 may be formed integrally with the wall of the main body 11 or may be formed adjacent to the inner wall of the main body 11. Accordingly, the sensor arrangement 21 can sense the existence and position of the fingers, for example, when the main body 11 is gripped with the hand. The sensor arrangement 21 has a plurality of independent and spatially separated sensing points arranged in each component.

The sensing points may be positioned on a grid or a pixel array. The sensing points converted into pixels may produce signals, respectively. In the simplest case, a signal is produced whenever the finger is positioned at the sensing point. When the finger is positioned on a plurality of sensing points or when the finger moves between or over a plurality of sensing points, multiple position signals are produced. In most cases, a number, combination and frequency of the signals are monitored by the controller 30 which converts control information. The number, combination and frequency of the signals in a certain time frame may represent a size, position, direction, speed, acceleration and pressure of the fingers on the surfaces of the touch pads 20A and 20B.

The portions of the fingers which have touched the touch pads 20A and 20B produce the touch regions Pt, Pi, Pn and Pr. Each of the touch regions covers a plurality of sensing points to produce multiple signals. The signals are grouped to represent which portions of the touch pads 20A and 20B gripped by the fingers of the user.

Meanwhile, in the above description, the thumb, the index finger, the middle finger and the ring finger are used for convenience of the description. The controller 30, which receives a single touch input or multiple touch inputs from the touch pads 20A and 20B, perceives that one finger has touched the second touch pad 20B and three fingers have touched the first touch pad 20A. In this case, since the controller 30 can perceive the positions of the three fingers having touched the first touch pad 20A, the controller 30 can identify the fingers gripping the main body 11. As another example, when one finger has touched the second touch pad 20B and four fingers have touched the first touch pad 20A, the controller 30 can perceive that the finger having touched the second touch pad 20B is the thumb and the fingers having touched the first touch pad 20A are the index finger, the middle finger, the ring finger and the little finger sequentially from top to bottom. Further, the controller 30 can sense the pressure of the finger which has touched the touch pad 20A or 20B. Accordingly, if the sensed pressure value is below a predetermined value, a determination may be made as a “contact” state in which the finger is in contact with the touch pad. If the sensed pressure value is equal to or larger than a predetermined value, a determination may be made as a “pressing” state in which the finger presses the touch pad. Additionally, if a plurality of reference pressure values are set, the controller 30 can perceive “contact”, “non-contact”, “pressing” and “non-pressing” states.

When the finger presses the surface of the touch pad 20A or 20B, a certain region of the touch region increases to thereby operate more sensing points than before.

Further, when the finger slides and moves from a first position to a second position on the surface of the touch pad 20A or 20B, the touch region moves such that the sensing points are inactivated at a present position and the sensing points are activated at a new position.

Further, when a contact state or a pressing state of the finger on the surface of the touch pad 20A or 20B is cancelled, a certain region of the touch region decreases to thereby operate fewer sensing points than before. Further, when one finger or two or more fingers tap the surface of the touch pads 20A and 20B at the same time or in order, each touch region disappears and then appears in a specific time period such that the sensing points are inactivated at a present position, and then are activated again.

Further, when one finger or two or more fingers provide different numbers of taps on the surface of the touch pads 20A and 20B, the respective touch regions disappear and then appear in a specific time period at different numbers such that the sensing points are inactivated at a present position, and then are activated again at different numbers. As a result, the controller 30 can perceive contact, non-contact, press, press removal, contact movement, press movement, tap and tapping number, thereby distinguishing the operation of the fingers.

Although will be described later, in the present general inventive concept, the operation of the fingers is determined while the main body 11 is gripped with the fingers in a standard shape. Then, the corresponding command is perceived and executed. In the determination of the operation of the fingers, a determination is made whether the gripping fingers are in a contact state, a contact removal state, a press state, a press removal state, a tapping state or a dragging state, or the fingers perform a single or combined operation.

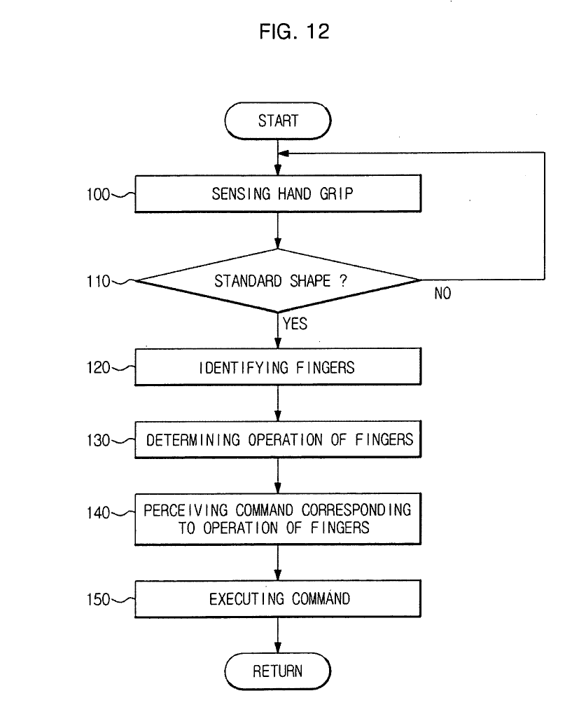

FIG. 12 is a view illustrating a control flowchart illustrating a control method of the handheld device according to the embodiment of the present general inventive concept.

Referring to FIG. 12, a hand grip shape in which the user grips the main body 11 is sensed in an operation mode 100 by checking the positions of the fingers gripping the touch pads 20.

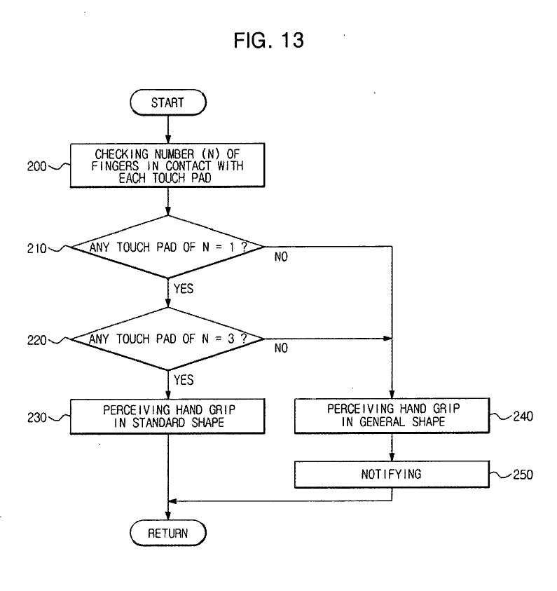

After the user's hand grip shape is sensed, in an operation mode 110, a determination is made whether the sensed hand grip shape is a preset standard shape. There will be described an example wherein the preset standard shape is the hand grip shape illustrated in FIG. 10 in which one finger is in contact with any one touch pad of the second touch pad 20B positioned on one side surface of the main body 11 and the first touch pad 20A positioned on the other side surface, and three fingers are in contact with the other touch pad. As illustrated in FIG. 13, the number of the fingers in contact with each of the second touch pad 20B and the first touch pad 20A is checked in an operation mode 200. A determination is made whether one finger is in contact with any one touch pad of the second touch pad 20B and the first touch pad 20A and three fingers are in contact with the other touch pad in operation modes 210 and 220. If one finger is in contact with one touch pad and three fingers are in contact with the other touch pad, a determination is made that the present hand grip shape is the standard shape in an operation mode 230. If not, a determination is made that the present hand grip shape is not the standard shape but a general shape in an operation mode 240. Then, in an operation mode 250, a hand grip error is displayed on a display unit provided in the main body to notify the user that the present hand grip shape is not the standard shape. Further, producing an error sound through a voice output unit, or vibrating the handheld device 10 is possible.

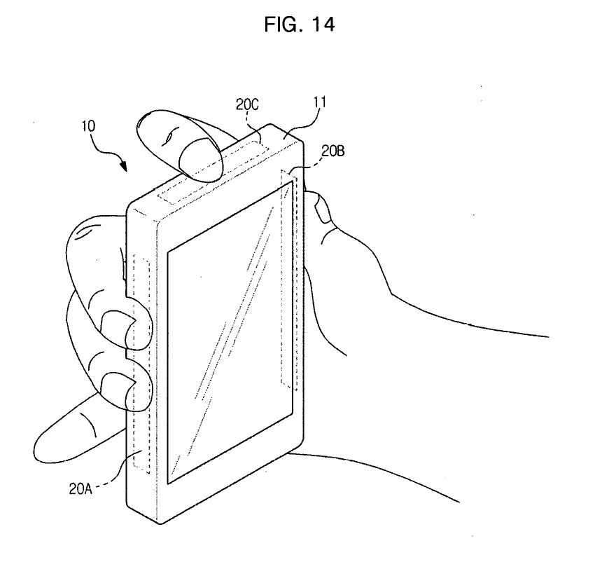

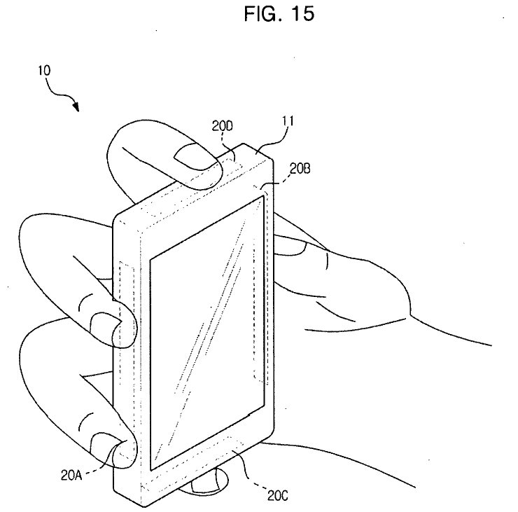

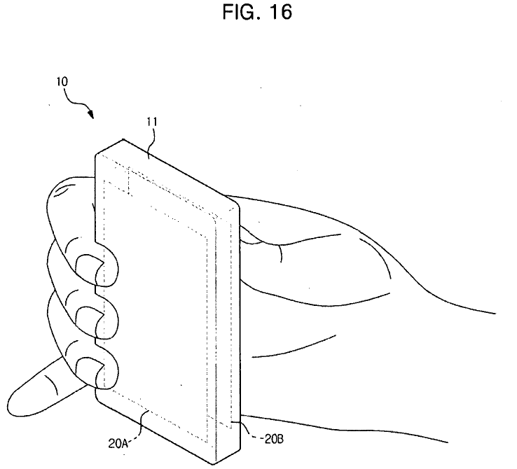

In the above-described method, only the number of the fingers in contact with each touch pad is checked without restriction of the positions of the first and second touch pads. Accordingly, although the user grips the handheld device 10 upside down, a determination may be made that hand grip shape is the standard shape. Thus, removing the user's inconvenience of gripping the handheld device 10 in a specified manner is possible. The standard shape may be any one of hand grip shapes in which the number of the fingers in contact with the touch pads positioned on at least two surfaces of the main body is at least three, and the fingers are in contact with at least two surfaces. That is, any hand grip shape satisfying these conditions may be set as a standard shape. FIGS. 14 to 16 illustrate various standard shapes of hand grip. The standard shape is stored in advance in the memory 31 as data corresponding to the standard shape.

If a determination is made that the hand grip shape is the standard shape, the gripping fingers are identified in an operation mode 120. As described above, when the fingers grip the main body 11, the existence and position of the fingers can be sensed by the sensor arrangement 21 of the touch pad 20. That is, the sensor arrangement has a plurality of independent and spatially separated sensing points arranged in each component. When the finger is positioned at the sensing points, perceiving the touch region and identifying the gripping finger is possible.

After the gripping finger is identified, the operation of the gripping finger is perceived in an operation mode 130. As described above, when the finger presses the surface of the touch pad 20, a certain region of the touch region increases to thereby operate more sensing points than before. Further, when the finger slides and moves from a first position to a second position on the surface of the touch pad 20, the touch region moves such that the sensing points are inactivated at a present position and the sensing points are activated at a new position. Further, when a contact state or a pressing state of the finger on the surface of the touch pad 20 is cancelled, a certain region of the touch region decreases to thereby operate fewer sensing points than before. As a result, the controller 30 can perceive contact, non-contact, press, press removal, movement and the like, thereby determining the operation of the fingers.

After the operation of the fingers is perceived, a command corresponding to the operation of the fingers is perceived in an operation mode 140, and the perceived command is executed in an operation mode 150. For this, the applications and the functions of the applications corresponding to the various operations of the fingers are stored in a table in the memory 31 in advance.

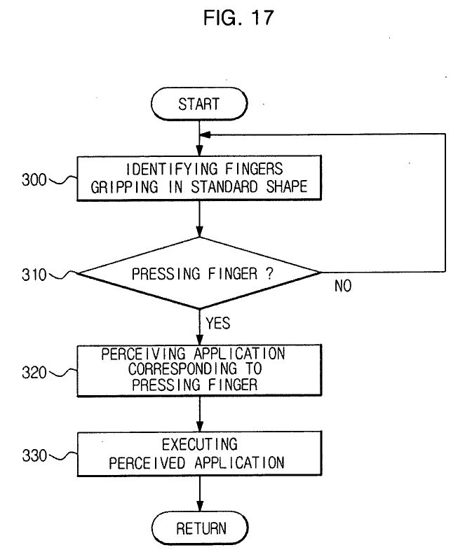

FIG. 17 is a view illustrating a process of perceiving the application commanded based on the operations of the fingers and executing the application in the handheld device according to the embodiment of the present general inventive concept.

Referring to FIG. 17, the fingers gripping in the standard shape are identified in an operation mode 300, and then, a determination is made whether there is a finger pressing the touch pad among the gripping fingers in an operation mode 310.

If there is a pressing finger, an application corresponding to the pressing finger is perceived in an operation mode 320, and the perceived application is executed in an operation mode 330.

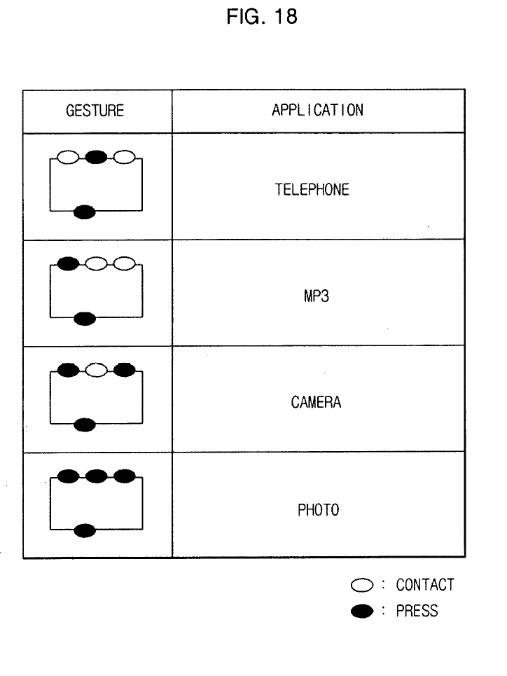

FIG. 18 is a table illustrating operations of the fingers in a left column and corresponding applications in a right column. The table of FIG. 18 will be described with reference to FIGS. 10 and 11.

When the standard shape is the hand grip shape of FIG. 10, wherein one finger is in contact with any one touch pad of the second touch pad 20B and the first touch pad 20A and three fingers are in contact with the other touch pad, for convenience of the description, the fingers may be identified as the thumb, the index finger, the middle finger and the ring finger, respectively, as illustrated in FIG. 11.

In the above-described standard shape, when the thumb and the middle finger press the touch pads, such operation of the fingers is perceived and the corresponding application “TELEPHONE” is executed. The application “TELEPHONE” is provided for general phone functions. Further, when the thumb and the ring finger press the touch pads, such operation of the fingers is perceived and the corresponding application “MP3” is executed. The application “MP3” is used to reproduce MP3 files. Further, when the thumb, the index finger and the ring finger press the touch pads at the same time, such operation of the fingers is perceived and the corresponding application “CAMERA” is executed. The application “CAMERA” is used to take a picture. Further, when the thumb, the index finger, the middle finger and the ring finger press the touch pads at the same time, such operation of the fingers is perceived and the corresponding application “PHOTO” is executed. The application “PHOTO” is used to see pictures.

As described above, it can be seen that the application is changed according to the pressing fingers among the fingers gripping the main body 11. In this case, even while the application is changed by the operation of the fingers, when the main body 11 is gripped in the standard shape, returning to a preset application is possible.

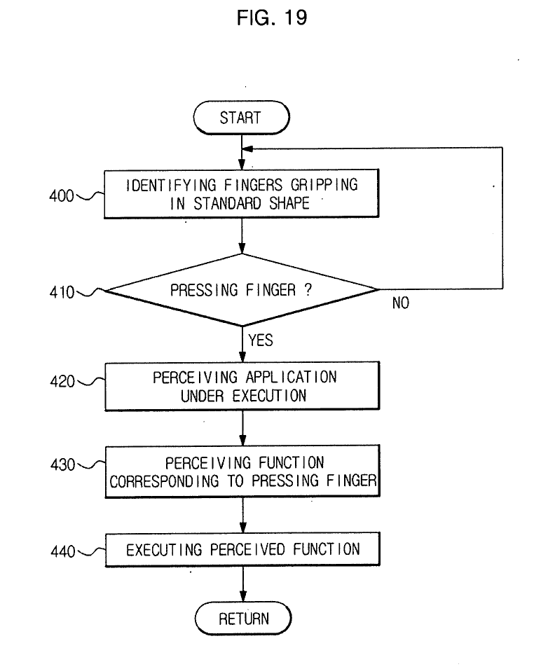

Meanwhile, FIG. 19 is a view illustrating a process of perceiving the function of the application under execution based on the operations of the fingers and executing the function in the handheld device according to the embodiment of the present general inventive concept.

Referring to FIG. 19, the fingers gripping in the standard shape are identified in an operation mode 400, and then, a determination is made whether there is a finger pressing the touch pad among the gripping fingers in an operation mode 410.

If there is a pressing finger, the application under execution is perceived in an operation mode 420.

After the application under execution is perceived, the application function corresponding to the pressing finger is perceived in an operation mode 430, and the perceived application function is executed in an operation mode 440.

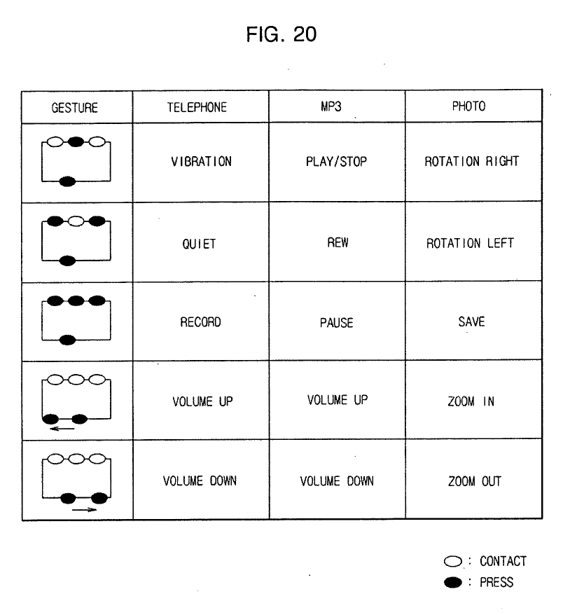

FIG. 20 is a table illustrating operations of the fingers in the leftmost column and application functions according to the types of applications in right columns. The table of FIG. 20 will be described with reference to FIGS. 10 and 11.

When the standard shape is the hand grip shape illustrated in FIG. 10, wherein one finger is in contact with any one touch pad of the second touch pad 20B and the first touch pad 20A and three fingers are in contact with the other touch pad, for convenience of the description, the fingers may be identified as the thumb, the index finger, the middle finger and the ring finger, respectively, as illustrated in FIG. 11.

In the above-described standard shape, when the thumb and the middle finger press the touch pads, the application under execution is determined. If the application under execution is “TELEPHONE”, a function “VIBRATION” corresponding to the operation of the fingers in the multiple functions of “TELEPHONE” is executed. Further, if the application under execution is “MP3”, a function “PLAY/STOP” corresponding to the operation of the fingers in the multiple functions of “MP3” is executed. Further, if the application under execution is “PHOTO”, a function “ROTATION RIGHT” corresponding to the operation of the fingers in the multiple functions of “PHOTO” is executed.

According to the present general inventive concept, it can be seen that the application function is changed according to the pressing fingers among the fingers gripping the main body 11. In this case, even while the application function is changed by the operation of the fingers, when the main body 11 is gripped in the standard shape, returning to a preset function of the application under execution is possible.

The present general inventive concept can also be embodied as computer-readable codes on a computer-readable medium. The computer-readable medium can include a computer-readable recording medium and a computer-readable transmission medium. The computer-readable recording medium is any data storage device that can store data that can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

Although various embodiments of the present general inventive concept have been illustrated and described, it would be appreciated by those skilled in the art that changes may be made in this embodiment without departing from the principles and spirit of the general inventive concept, the scope of which is defined in the claims and their equivalents.

What is claimed is:

1. A method to use a user interface, the method comprising:
sensing a standard hand grip;
identifying gripping fingers when the standard hand grip is sensed;
determining an operation of the identified fingers;
perceiving a command based on the determined operation of the fingers; and
executing the perceived command.

2. The method of claim 1, wherein the standard hand grip is preset as any one of hand grip shapes in which a number of fingers in contact with touch pads positioned on at least two surfaces of a main body is at least three, and the fingers are in contact with at least two surfaces.

3. The method of claim 1, wherein the identifying gripping fingers includes identifying the fingers as at least three fingers of a thumb, an index finger, a middle finger, a ring finger and a little finger.

4. The method of claim 1, wherein the identifying gripping fingers includes sensing positions of the gripping fingers and identifying the gripping fingers based on the sensed positions of the fingers.

5. The method of claim 1, wherein the determined operation of the fingers is any one of a pressing operation of at least one finger among the gripping fingers, a pressing/moving operation of at least one finger among the gripping fingers, a contact removal operation of at least one finger among the gripping fingers, and a tapping operation of at least one finger among the gripping fingers, or a combination thereof.

6. The method of claim 1, wherein the determined operation of the fingers is a tapping operation of at least two fingers among the gripping fingers tapping simultaneously or sequentially.

7. The method of claim 1, wherein the determined operation of the fingers is a tapping operation of at least one finger among the gripping fingers to provide a predetermined number of taps.

8. The method of claim 1, wherein the perceiving a command includes perceiving the command based on preset corresponding commands according to the determined operation of the fingers.

9. The method of claim 8, wherein the command changes an application under execution to an application corresponding to the determined operation of the fingers.

10. The method of claim 8, wherein the command changes a function of an application under execution to an application function corresponding to the determined operation of the fingers.

11. A user interface apparatus, comprising:
a main body having at least two surfaces;
touch pads provided on the at least two surfaces;
a controller to identify gripping fingers when a standard hand grip is sensed through the touch pads, and to perceive and execute a command based on an operation of the identified fingers.

12. The apparatus of claim 11, wherein the standard hand grip is preset as any one of hand grip shapes in which the number of fingers in contact with the touch pads is at least three, and the fingers are in contact with at least two surfaces.

13. The apparatus of claim 11, wherein the controller identifies the fingers as at least three fingers of a thumb, an index finger, a middle finger, a ring finger and a little finger.

14. The apparatus of claim 11, wherein the controller identifies the gripping fingers based on contact positions of fingers gripping the touch pads.

15. The apparatus of claim 11, wherein the controller perceives that the operation of the fingers is any one of a pressing operation of at least one finger among the gripping fingers, a pressing/moving operation of at least one finger among the gripping fingers, a contact removal operation of at least one finger among the gripping fingers, and a tapping operation of at least one finger among the gripping fingers, or a combination thereof.

16. The apparatus of claim 11, wherein the controller perceives that the operation of the fingers is a tapping operation of at least two fingers among the gripping fingers tapping simultaneously or sequentially.

17. The apparatus of claim 11, wherein the controller perceives that the operation of the fingers is a tapping operation of at least one finger among the gripping fingers to provide a predetermined number of taps.

18. The apparatus of claim 11, wherein the controller determines the operation of the identified fingers and perceives the command based on preset corresponding commands according to the determined operation of the fingers.

19. The apparatus of claim 18, wherein the command changes an application under execution to an application corresponding to the determined operation of the fingers.

20. The apparatus of claim 18, wherein the command changes a function of an application under execution to an application function corresponding to the determined operation of the fingers.

21. A handheld user interface apparatus, comprising:
a main body to be held by a hand of a user;
a plurality of touch pads disposed on the main body, and to correspond to and receive input from respective fingers of the hand of the user; and
a controller to determine which of the touch pads receive input and a type of input received thereto, and to execute a command based on the determination.

22. The apparatus of claim 21, wherein the type of input includes one or more of a pressing operation, a pressing/moving operation, a contact removal operation, a contact duration operation, and a tapping operation, or a combination thereof.

23. The apparatus of claim 22, further comprising:
a memory to store a plurality of commands, and combinations of the types of input to be received by the touch pads and the respective touch pads to receive the input required to execute the respective commands.

24. A method of operating a handheld user interface apparatus, the method comprising:
determining which of a plurality of touch pads respectively corresponding to fingers of a hand of a user receive an input;
determining a type of input received by the determined touch pads; and
executing a command based on the determined plurality of touch pads to receive the input and the type of input received.

25. A method of operating a handheld computer (HHC), comprising:
determining characteristics of finger placement on at least two touch pads disposed on sides of the HHC; and
executing predetermined commands of the HHC based on the determined characteristics of the finger placement.

26. The method of claim 25, wherein the determined characteristics of the finger placement includes a type of grip of the HHC.

27. The method claim 26, wherein the type of grip includes a pressure applied to the touch pads.

28. The method of claim 25, wherein the characteristics of the finger placement include positioning of the fingers and the number of fingers on the touch pad.

29. A computer-readable recording medium having embodied thereon a computer program to execute a method, wherein the method comprises:
determining which of a plurality of touch pads respectively corresponding to fingers of a hand of a user receive an input;
determining a type of input received by the determined touch pads; and
executing a command based on the determined plurality of touch pads to receive the input and the type of input received.
